(19) United States
(12) Patent Application Publication
(10) Pub. No.: US 2022/0140924 A1
(43) Pub. Date: May 5, 2022

(54) MOBILE DATA COLLECTION APPARATUS

(71) Applicant: AES CONTROLS INC., Cincinnati, OH (US)

(72) Inventor: Asif J. AHMED, Maineville, OH (US)

(21) Appl. No.: 17/520,432

(22) Filed: Nov. 5, 2021

Related U.S. Application Data
(60) Provisional application No. 63/110,156, filed on Nov. 5, 2020.

(51) Int. Cl. H04B 17/318; H04L 29/08; H04W 4/029; H04W 4/38

(52) U.S. Cl. CPC H04B 17/318; H04W 4/38; H04W 4/029; H04L 67/12

(57) ABSTRACT

Methods, systems, and apparatuses are described that are configured for collecting, via a plurality of sensors, and processing, various types of data via a mobile data collection apparatus.

### CROSS-REFERENCE TO RELATED APPLICATION

This application claims priority to, and the benefit of, U.S. Provisional Application No. 63/110,156, filed Nov. 5, 2020, the entirety of which is herein incorporated by reference.

### BACKGROUND

As big data becomes more ubiquitous, private companies and government entities rely on larger and larger data sets. However, traditional methods of data collection rely largely rely on individuals (e.g., customers) volunteering personal information through surveys or polls. With regards to wireless communication data, most data collection happens in a passive manner wherein data is collected when a user enters network coverage and logs onto a network through an access point. Such methods rely on user action and cannot proactively gather data at locations beyond the coverage of the wireless access point. Thus, there is a need for mobile data collection that can determine a user's location and gather data wherever the user is.

### SUMMARY

In an embodiment, methods, systems, and apparatuses are described for mobile data collection. The apparatus may comprise a communications sensor, configured for detecting wireless communications in an environment of the apparatus and further configured for generating wireless communication data, and a computing device, wherein the computing device is configured to receive, process, and transmit the wireless communication data. In an embodiment, the apparatus may be mounted on a micromobility scooter. In an embodiment, the apparatus may be carried by a user, for example in or on a backpack. In an embodiment, the apparatus may be carried in an automobile or disposed on the exterior of the automobile.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive.

### BRIEF DESCRIPTION OF THE DRAWINGS

To easily identify the discussion of any particular element or act, the most significant digit or digits in a reference number refer to the figure number in which that element is first introduced.

FIG. 1 shows an example system;

FIG. 2 shows an example system;

FIG. 3 shows an example system;

FIG. 4 shows an example data;

FIGS. 5A-5B show example data;

FIG. 6 shows an example device;

FIG. 7 shows an example method; and

FIG. 8 shows an example system.

### DETAILED DESCRIPTION

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes-from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the examples included therein and to the Figures and their previous and following description.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Hereinafter, various embodiments of the present disclosure will be described with reference to the accompanying drawings. As used herein, the term “user” may indicate a person who uses an electronic device or a device (e.g., an artificial intelligence electronic device) that uses an electronic device.

In an embodiment, a mobile data collection apparatus is described. The mobile data collection apparatus may comprise a smart scooter. The smart scooter may be configured to scan a surface in proximity to the smart scooter.

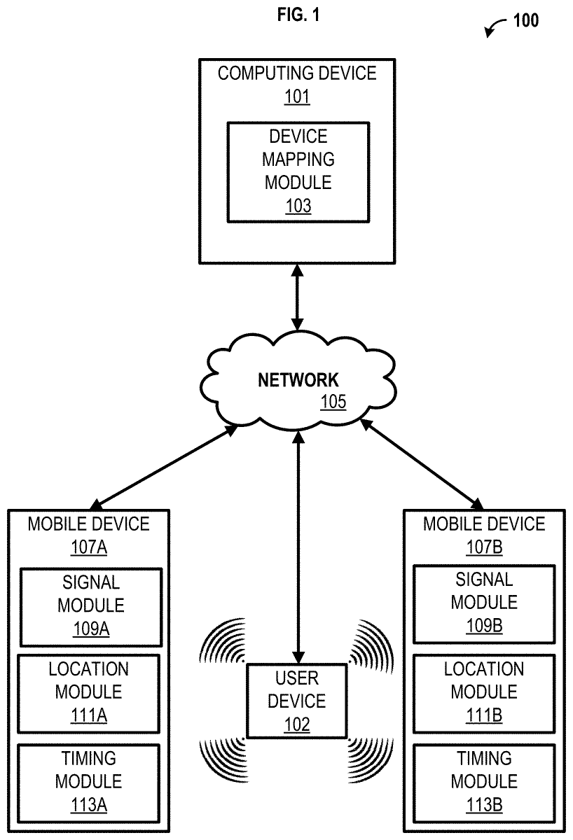

FIG. 1 shows an example system 100. The system 100 may comprise a computing device 101, at least one user device 102, a network 105, a first mobile device 107A, and a second mobile device 107B. While FIG. 1 shows a single computing device, a single user device, a single network, and two mobile devices, it will be appreciated by one in the art that this description is merely exemplary and explanatory and that, in practice, any number, even large numbers of computing devices, user devices, networks, and mobile devices may be involved. For example, the system may comprise thousands of mobile devices and thousands of user devices. The network 105 may be an optical fiber network, a coaxial cable network, a hybrid fiber-coaxial network, a wireless network, a satellite system, a direct broadcast system, or any combination thereof. The network 105 can be the Internet. The network may be a local area network (LAN). The network may be a low-energy communications network such as a Bluetooth or zigbee network. The network 105 may have a network component. The network component may be any device, module, combinations thereof, and the like communicatively coupled to the network. The network component may be a router, a switch, a splitter, a packager, a gateway, an encoder, a storage device, a multiplexer, a network access location (e.g., tap), physical link, combinations thereof, and the like.

The user device 102 may be a smart phone, computer, tablet, combinations thereof, and the like. The user device 102 may be configured to send and receive data. For example, the user device 102 may be configured to send one or more beacons. The one or more beacons may be configured to determine one or more network configuration parameters associated with the network 105. For example, the user device 102 may send (e.g., broadcast) a first beacon. The first beacon may comprise a data packet. The data packet may comprise information associated with the user device 102. For example, the data packet may comprise a user device identifier associated with the user device 102. The user device identifier may be a unique identifier of the user device 102. For example, the user device identifier may comprise a MAC address, OEM ID, or other unique identifier. The data packet may comprise an 802.11 beacon frame. The data packet may comprise a transmit power associated with the data packet. The transmit power associated with the data packet may indicate a power (e.g., in decibels or other units) at which the beacon was transmitted form the user device 102. The data packet may contain other information such as a location, a transmit time (e.g., a clock time and/or a duration of a transmission) modulation rate, packet size, or other information. The user device 102 may be configured to communicate via the Bluetooth standard. The Bluetooth standard is a short-range wireless communication industry specification that allows portable, personal devices to interact with each other and other devices. When one Bluetooth device comes within range of another, they automatically exchange address and capability details. They can then establish a 1-megabit/second link with security and error correction.

The first mobile device 107A may comprise a signal module 109A, a location module 111A, and a timing module 113A. The first mobile device 107A may comprise a signal analysis device, a data gathering device, a packet sniffing device, combinations thereof, and the like. The signal module 109A may be configured to process the data packet. The signal module 109A may be configured to determine the user device identifier. The signal module 109A may be configured to determine one or more signal characteristics associated with the data packet. The one or more signal characteristics may comprise at least one of: a received signal strength indicator (RSSI), a transmit strength indicator (TSI), a direction of origin, a data packet format, a network history (e.g., networks previously associated with the device), a device type, a network traffic indicator, a packet loss rate, combinations thereof, and the like. For example, the signal module 109A may be configured to determine a first received signal strength indicator (RSSI) associated with the data packet. The first RSSI may indicate a signal strength (e.g., as measured in decibels or other units) at which the data packet was received. The signal module 109A may comprise one or more antennas. Using the one or more antennas, the signal module 109A may be configured to determine a broadcast direction (e.g., the direction of origin) associated with the data packet. For example, the one or more antennas may be configured to determine a direction from which the data packet was broadcast. For example, a first antenna of the one or more antennas may detect the data packet before a second antenna of the one or more antennas and thereby determine a direction from the data packet was broadcast.

The first mobile device 107A may comprise a location module 111A. The location module 111A may be configured to determine a first location. The first location may be associated with the first mobile device. The location module may comprise at least one of: a Global Navigation Satellite System (GNSS) module, a Global Positioning System (GPS), Global Navigation Satellite System (Glonass), Beidou Navigation Satellite System (hereinafter, “Beidou”), Galileo, the European global satellite-based navigation system, combinations thereof, and the like. Hereinafter, the “GPS” and the “GNSS” may be used interchangeably in the present document. The mobile device 107A may include a location sensor for determining its current position and forwarding such location information and an associated time stamp to the host server. For example, the mobile device 107A may include a cell-triangulation sensor for triangulating the location of the device based on the area identity transmission or the like of base stations (e.g., based on at least three of the strongest base station signals), GPS system or other types of sensors or combination of sensors to identify a location of the device.

The first mobile device 107A may comprise timing module 113A. The timing module may be configured to determine a first time. The first time may be associated with a time at which the data packet was received.

The first mobile device 107A may be configured to send and receive data to and from the computing device 101 via the network 105. For example, the first mobile device 107A may be configured to send, to the computing device 101, via the network 105, first signal data, first location data, and first timing data. For example, the first mobile device 107A may send to the computing device 101 first signal data indicative of the first RSSI, first location data indicative of the first location, and first timing data associated with the time at which the data packet was detected by the first mobile device 107A.

The mobile device 107A may provide movement information, such as location or position, either passively or actively to, for example, the computing device 101. Passive provision of movement information may involve registration of the mobile device 107A with the mobile network, such as with cellular units, or a service discovery/negotiation operation involving a fixed position Bluetooth transceiver with a Bluetooth-enabled mobile device. Such information may thereafter be time-stamped and forwarded to computing device 101 to perform the various processes discussed herein.

Active provision of information may entail mobile device 107A determining movement characteristics—for example, through use of location sensors—and providing such information to computing device 101 to perform the various processes discussed herein. Such sensors may include GPS, cellular position triangulation sensor and/or other sensors to sense movement characteristics of the mobile device or to sense environmental characteristics to enable determination of movement characteristics.

The second mobile device 107B may comprise a signal module 109B, a location module 111B, and a timing module 113B. The second mobile device 107B may comprise a signal analysis device, a data gathering device, a packet sniffing device, combinations thereof, and the like. The signal module 109B may be configured to process the data packet. The signal module 109B may be configured to determine the user device identifier. The signal module 109B may be configured to determine one or more signal characteristics associated with the data packet. For example, the signal module 109B may be configured to determine a second received signal strength indicator (RSSI) associated with the data packet. The second RSSI may indicate a second signal strength (e.g., as measured in decibels or other units) at which the data packet was received. The signal module 109B may comprise one or more antennas. Using the one or more antennas, the signal module 109B may be configured to determine a broadcast direction associated with the data packet. For example, the one or more antennas may be configured to determine a direction from which the data packet was broadcast. For example, a first antenna of the one or more antennas may detect the data packet before a second antenna of the one or more antennas and thereby determine a direction from the data packet was broadcast.

The second mobile device 107B may comprise a location module 111B. The location module 111B may be configured to determine a second location. The second location may be associated with the second mobile device 107B. The location module may comprise at least one of: a Global Navigation Satellite System (GNSS) module, a Global Positioning System (GPS), Global Navigation Satellite System (Glonass), Beidou Navigation Satellite System (hereinafter, “Beidou”), Galileo, the European global satellite-based navigation system, combinations thereof, and the like. Hereinafter, the “GPS” and the “GNSS” may be used interchangeably in the present document. The mobile device 107B may include a location sensor for determining its current position and forwarding such location information and an associated time stamp to the host server. For example, the mobile device 107B may include a cell-triangulation sensor for triangulating the location of the device based on the area identity transmission or the like of base stations (e.g., based on at least three of the strongest base station signals), GPS system or other types of sensors or combination of sensors to identify a location of the device.

The second mobile device 107B may comprise timing module 113B. The timing module may be configured to determine a second time. The second time may be associated with a time at which the data packet was received by the second mobile device 107B.

The second mobile device 107B may be configured to send and receive data to and from the computing device 101 via the network 105. For example, the second mobile device 107B may be configured to send, to the computing device 101, via the network 105, second signal data, second location data, and second timing data. For example, the second mobile device 107B may send to the computing device 101 second signal data indicative of the second RSSI, second location data indicative of the second location, and second timing data associated with the time at which the data packet was detected by the second mobile device 107B.

The mobile device 107B may provide movement information, such as location or position, either passively or actively to, for example, the computing device 101. Passive provision of movement information may involve registration of the mobile device 107B with the mobile network, such as with cellular units, or a service discovery/negotiation operation involving a fixed position Bluetooth transceiver with a Bluetooth-enabled mobile device. Such information may thereafter be time-stamped and forwarded to computing device 101 to perform the various processes discussed herein. Active provision of information may entail mobile device 107B determining movement characteristics—for example, through use of location sensors—and providing such information to computing device 101 to perform the various processes discussed herein. Such sensors may include GPS, cellular position triangulation sensor and/or other sensors to sense movement characteristics of the mobile device or to sense environmental characteristics to enable determination of movement characteristics.

The computing device 101 may comprise a device mapping module 103. The device mapping module 103 may be configured to determine map data. For example, the device mapping module 103 may be configured to download one or more maps or other similar data. The computing device 101 may be configured to receive at least one of the first signal data, the second signal data, the first location data, the second location data, the first timing data, or the second timing data. The device mapping module 103 may be configured to determine, based on at least one of the first signal data, the second signal data, the first location data, the second location data, the first timing data, or the second timing data, a third location. The third location may be associated with the user device 102. While the above describes the present methods and systems using two mobile devices and a single user device it is to be understood that the present methods may be carried out repeatedly and/or in a system comprising many (e.g., thousands) of mobile devices and user devices. Thus, the device mapping module may, by virtue of receiving the above described information may determine user device density information (e.g., how many user devices are located within a given area) and/or user device traffic data (e.g., how one or more user devise move about the given area).

A data feed containing updates of user device user information (such as location information or other information) may be collected into the device mapping module (e.g., a database). The data feed can be obtained from a variety of sources, (e.g., through network elements or through explicit communication with the user device of a user). For example, information about the location of a user can be obtained through sources such as periodic cell phone registrations with a mobile device, updates from mobile GPS units, and so on. The database may be centralized or distributed, may be a general-purpose user location database, may be specialized to a particular task, or may be federated from a number of special purpose databases.

A variety of user device information can be collected in the database, including calling and browsing patterns of a user device, a vector of recent location updates (and the timestamps of these updates) of a user device, profile information about a user (including preferred travel routes), and so on. Based on this information, user devices can be dynamically categorized into groups that share similar properties or traits and services can be customized for users.

As one illustrative example, the method and system discussed herein may be applied to determine optimal access point placement based on user device congestion, traffic, or other related patterns. As one illustrative example, the method and system discussed herein may be applied to detect environmental conditions, such as traffic jams or congestion, by tracking movement or location of a plurality of user devices.

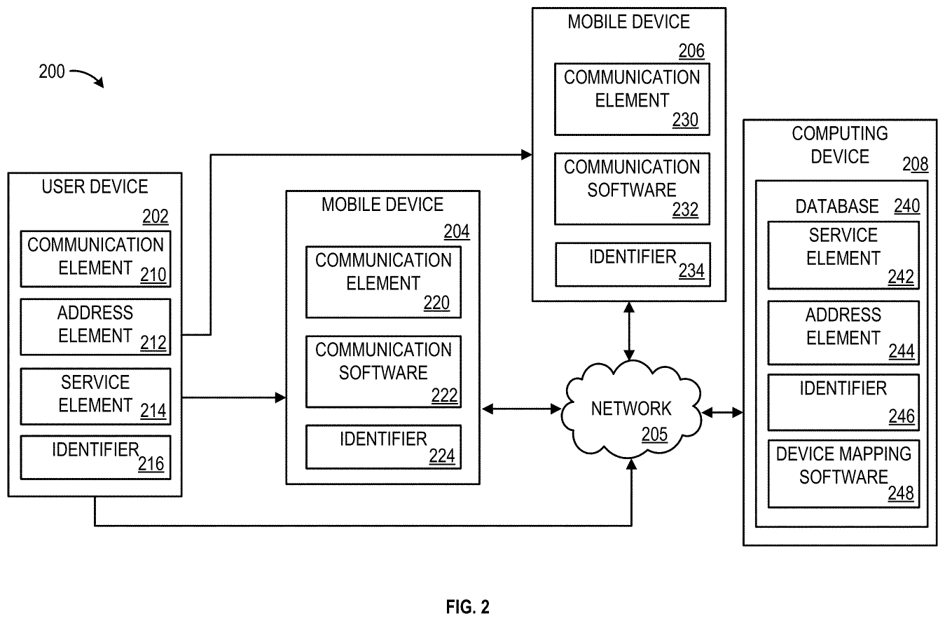

FIG. 2 shows a system 200 for wireless communication. The system 300 may comprise a user device 202 (e.g. the user device 102), a first mobile device 204 (e.g. the mobile device 107A), a second mobile device 206 (e.g., the mobile device 107B), a network 205 (e.g., the network 105), and a computing device 208 (e.g., the computing device 101). The network 205 may facilitate the connection the sending and receiving of data (e.g., location data, timing data, identifiers, packets, combinations thereof, and the like) between the various devices of FIG. 2.

The user device 202 may comprise a communication element 210, an address element 212, a service element 214, and an identifier 216. The user device 202 may be an electronic device such as a computer, a smartphone, a laptop, a tablet, a set top box, a display device, or other device capable of communicating with the network 205. The communication element 210 may be a wireless transceiver configured to transmit and receive wireless communications via a wireless network (e.g., Wi-Fi, Bluetooth, Zigbee, 4G, 5G, combinations thereof, and the like). The communication element 210 may be configured to communicate via one or more wireless networks. The communication element 210 may be configured to communicate via a specific network protocol. The user device 202 may communicate with the mobile device 204 and/or the mobile device 206 via the communication element 210.

The user device 202 may comprise an address element 212 and a service element 214. The address element 212 may comprise or provide an internet protocol address, a network address, a media access control (MAC) address, an Internet address, or the like. The address element 212 may be relied upon to establish a communication session between the user device 202 and the network device 204 or other devices and/or networks. The address element 212 may be used as an identifier or locator of the primary content device 302. The address element 212 may be persistent for a particular network.

The service element 214 may comprise an identification of a service provider associated with the user device 202 and/or with the class of user device 202. The class of the user device 202 may be related to a type of device, capability of device, type of service being provided, and/or a level of service (e.g., business class, service tier, service package, etc.). The service element 214 may comprise information relating to or provided by a communication service provider (e.g., Internet service provider) that may be providing or enabling data flow such as communication services to the primary content device 302. The service element 214 may comprise information relating to a preferred service provider for one or more particular services relating to the primary content device 302. The address element 212 may be used to identify or retrieve data from the service element 214, or vice versa. The one or more of the address element 212 and the service element 214 may be stored remotely from the user device 202. Other information may be represented by the service element 214.

The user device 202 may be associated with a user identifier or device identifier 216. The device identifier 216 may be any identifier, token, character, string, or the like, for differentiating one user or computing device (e.g., the computing device 308) from another user or computing device. The device identifier 216 may identify a user or computing device as belonging to a particular class of users or computing devices. The device identifier 216 may comprise information relating to the user device 202 such as a manufacturer, a model or type of device, a service provider associated with the user device 202, a state of the user device 202, a locator, and/or a label or classifier. Other information may be represented by the device identifier 216. The device identifier 216 may be assigned to the user device 202 by the network device 204 and/or the computing device 208.

The mobile device 204 may comprise a communication element 220, communication software 222, and an identifier 224. The network device 204 may be configured as a packet detector and/or packet analyzer. The mobile device 204 may be configured to detect one or more wireless communications originating from the user device 202. The mobile device 204 may be configured to determine information associated with the one or more wireless communications originating from the user device 202. For example, the mobile device 204 may be configured to determine the identifier 216.

The mobile device 204 may comprise communication software 222. The communication software 222 may be any combination of firmware, software, and/or hardware. The communication software 222 may facilitate the mobile device 204 communicating with the user device 202 and/or the computing device 208. For example, the mobile device 204 may detect the one or more wireless communications originating from the user device 202 and send the information associated with the one or more wireless communications to the computing device 208.

The communication element 220 may be a wireless transceiver configured to transmit and receive wireless communications via a wireless communication. The communication element 220 may be configured to communicate via a specific network protocol. The communication element 220 may be a wireless transceiver configured to communicate via a Wi-Fi network. The mobile device 204 may communicate with the user device 202 and/or the computing device 208 via the communication element 220.

The mobile device 204 may comprise an identifier 224. The identifier 224 may be or relate to an Internet Protocol (IP) Address IPV4/IPV6 or a media access control address (MAC address) or the like. The identifier 224 may be a unique identifier for facilitating wired and/or wireless communications with the mobile device 204.

The mobile device 206 may comprise a communication element 230, communication software 232, and an identifier 234. The mobile device 206 may be configured as a packet detector and/or packet analyzer. The mobile device 206 may be configured to detect one or more wireless communications originating from the user device 202. The mobile device 206 may be configured to determine information associated with the one or more wireless communications originating from the user device 202. For example, the mobile device 206 may be configured to determine the identifier 216.

The mobile device 206 may comprise communication software 232. The communication software 232 may be any combination of firmware, software, and/or hardware. The communication software 232 may facilitate the mobile device 206 communicating with the user device 202 and/or the computing device 208. For example, the mobile device 206 may detect the one or more wireless communications originating from the user device 202 and send the information associated with the one or more wireless communications to the computing device 208.

The communication element 230 may be a wireless transceiver configured to transmit and receive wireless communications via a wireless communication. The communication element 230 may be configured to communicate via a specific network protocol. The communication element 230 may be a wireless transceiver configured to communicate via a Wi-Fi network. The mobile device 206 may communicate with the user device 202 and/or the computing device 208 via the communication element 230.

The mobile device 206 may comprise an identifier 234. The identifier 234 may be or relate to an Internet Protocol (IP) Address IPV4/IPV6 or a media access control address (MAC address) or the like. The identifier 234 may be a unique identifier for facilitating wired and/or wireless communications with the mobile device 206.

The computing device 208 may comprise a database 240, a service element 242, an address element 244, an identifier 246, and device mapping software 248. The database 240 may store a plurality of files (e.g., records, documents, web pages), user identifiers or records, or other information. The user device 202 may, for example, request network access to the network 205 (e.g., via a beacon and/or packet). Based on the request, the mobile device may determine the information associated with the one or more wireless communications originating from the user device and send, to the computing device, the information. The database 240 may store the information relating to the user device 202 such as the address element 212 and/or the service element 212. The computing device 208 may obtain the device identifier 216 from the user device 202 and retrieve information from the database 240. Any information may be stored in and retrieved from the database 240. The database 240 may be disposed remotely from the computing device 208 and accessed via direct or indirect connection. The database 240 may be integrated with the computing device 208 or some other device or system.

The computing device 208 may comprise a service element 242. The service element 242 may comprise an identification of a service provider associated with the computing device 208 and/or with the class of computing device 208. The class of the computing device 208 may be related to a type of device, capability of device, type of service being provided, and/or a level of service (e.g., business class, service tier, service package, etc.). The service element 242 may comprise information relating to or provided by a communication service provider (e.g., Internet service provider) that may be providing or enabling data flow such as communication services to the computing device 208. The service element 242 may comprise information relating to a preferred service provider for one or more particular services relating to the computing device 208. Other information may be represented by the service element 242.

The address element 244 may comprise or provide an internet protocol address, a network address, a media access control (MAC) address, an Internet address, or the like. The address element 244 may be relied upon to establish a communication session between the computing device 208 and the network device 204 or other devices and/or networks. The address element 244 may be used as an identifier or locator of the computing device 208. The address element 244 may be persistent for a particular network.

The computing device 208 may comprise an identifier 246. The identifier 246 may be or relate to an Internet Protocol (IP) Address IPV4/IPV6 or a media access control address (MAC address) or the like. The identifier 246 may be a unique identifier for facilitating wired and/or wireless communications with the network device 204. The identifier 246 may be associated with a physical location of the computing device 208.

The computing device 208 may comprise device mapping software 248. The device software 248 may be configured to determine, based on the information associated with the one or more wireless communications originating from the user device 202, a device map. The device map may indicate a location of the user device 202. For example, the device map may indicate latitude and longitude of the user device, a relative location of the user device 202 (e.g., a location of the user device 202 relative to the mobile device 204 and/or the mobile device 206). The device mapping software may determine the location of more than one user device and thus determine user device density information and/or user device traffic information.

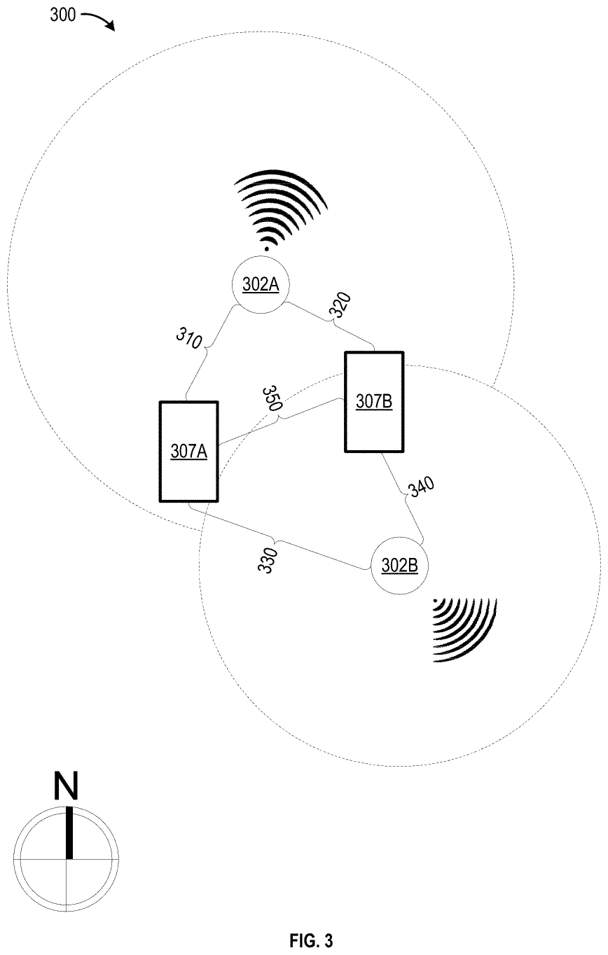

FIG. 3 shows an example system 300. The system 300 may be the system 100. The system 300 may comprise a first user device 302A, a second user device 302B, a first mobile device 307A, and a second mobile device 307B. Either or both of the first user device 302A and the second user device 302B may be the user device 102 of FIG. 1. Similarly, the first mobile device 307A and the second mobile device 307B may the first and second mobile devices 107A and 107B of FIG. 1. A person of skill in the art will appreciate that any number of user devices and mobile devices may be involved in the implementation of the methods described herein.

The first user device 307A may detect a first data packet (e.g., a broadcast such as a Wi-Fi beacon or Bluetooth beacon, any 802 packet, combinations thereof, and the like). The first data packet may originate from a first user device 302A. Based on receiving the first packet, the mobile device 307A may determine a first user device identifier associated with the first packet. The first user device identifier may be a MAC address, IP address, OEM identifier, token, string of characters, combinations thereof, and the like.

Based on detecting the first packet, the first mobile device 307A may determine first timing data. The first timing data may indicate a time at which the first mobile device 307A detected the first packet. The first timing data may be a wall-clock time or any other time. Based on detecting the first packet, the first mobile device 307A may determine first location data. The first location data may indicate a location of the mobile device 307A. The first location data may be associated with the first timing data. For example, the first location data may indicate a location of the first mobile device 307A when the first mobile device 307A detected the first data packet. The first location data may be GPS coordinates or any other suitable location data.

Based on receiving the first packet, the first mobile device 307A may determine one or more first signal characteristics associated with the first data packet. For example, a first signal characteristic of the one or more first signal characteristics may be a received signal strength indicator. The one or more first signal characteristics may comprise at least one of: a packet size, an RSSI, a transmit power, a device type, a network traffic indicator, a packet loss rate, a direction of origin, a packet format, combinations thereof, and the like. The first mobile device 307A may determine, based on at least one signal characteristic of the one or more signal characteristic a first proximity 310. The first proximity 310 may indicate a distance between (e.g., a proximity to) the first mobile device 307A and the first user device 302A. A first additional signal characteristic of the one or more signal characteristics may be a direction indicator. For example, the first mobile device 307A may be configured to determine a direction of origin of the data packet. For example, the first mobile device 307A may be configured with one or more directional antennas.

Similarly, the second mobile device 307B may detect the first data packet (e.g., a broadcast such as a Wi-Fi beacon or Bluetooth beacon, any 802 packet, combinations thereof, and the like). The first data packet may originate from the first user device 302A. Based on receiving the first packet, the second mobile device 307B may determine the first user device identifier associated with the first packet.

Based on detecting the first packet, the second mobile device 307B may determine second timing data. The second timing data may indicate a time at which the second mobile device 307B detected the first packet. The second timing data may be a wall-clock time or any other time. Based on detecting the first packet, the second mobile device 307B may determine second location data. The second location data may indicate a location of the second mobile device 307B. The second location data may be associated with the second timing data. For example, the second location data may indicate a location of the second mobile device 307B when the second mobile device 307B detected the first data packet. The second location data may be GPS coordinates or any other suitable location data.

Based on receiving the first packet, the second mobile device 307B may determine one or more second signal characteristics associated with the first data packet. The one or more second signal characteristics may be the same as, or different from, the one or more first signal characteristics. For example, a second signal characteristic of the one or more second signal characteristics may be a received signal strength indicator. The one or more signal characteristics may comprise at least one of: a packet size, an RSSI, a transmit power, a device type, a network traffic indicator, a packet loss rate, a direction of origin, a packet format, a network history (e.g., one or more networks to which the user device was previously associated), combinations thereof, and the like. The second mobile device 307B may determine, based on at least one second signal characteristic of the one or more second signal characteristic a second proximity 320. The second proximity indicator may indicate a distance between (e.g., a proximity to) the second mobile device 307B and the first user device 302A. A second additional signal characteristic of the one or more second signal characteristics may be a direction indicator. For example, the second mobile device 307B may be configured to determine a direction of origin of the data packet. For example, the second mobile device 307B may be configured with one or more directional antennas.

The above described system and method may be used to determine, for example proximities 330 and 340 (e.g., a distance between the first mobile device 307A and the user device 302B and a distance between the second mobile device 307B and the second user device 302B, respectively). Similarly, each of the first mobile device 307A and the second mobile device 307B may be configured to determine proximity 350 between them.

Each of the first mobile device 307A and the second mobile device 307B may be configured to send the first location data and first timing data, second location data and second timing data, the user device identifier, the one or more first signal characteristics, and the one or more second signal characteristics to a computing device. By repeatedly determining the location of the one or more user devices (e.g., by aggregation), the computing device may determine a device location history of each user device. Based on the device location history of each user device, the computing device may determine network holes. For example, the computing device may determine a first geographic location associated with heavy user device traffic (e.g., there is usually a large number of user devices at the first geographic area). The computing device may compare this first geographic location with a network map and determine whether a service provider provides an access point at the first geographic location. If not, the computing device may determine a need for an access point at the first geographic location. Conversely, the computing device may determine a second geographic location associated with little user device traffic. The computing device may determine an access point is not necessary at the second geographic location.

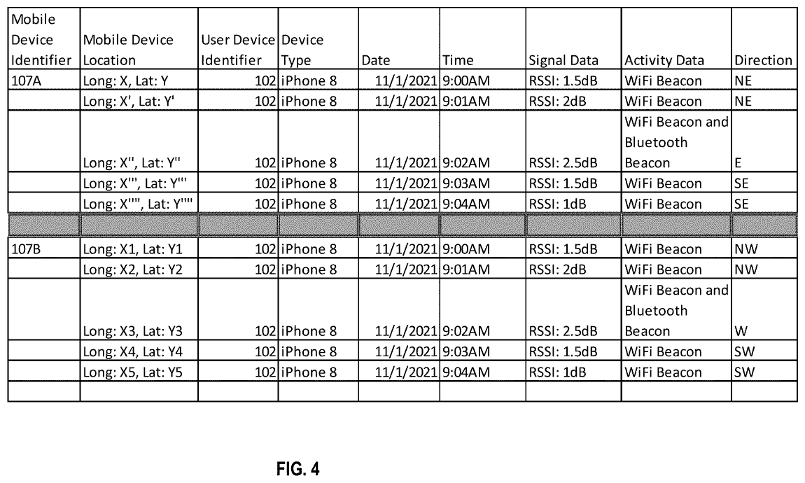

FIG. 4 shows example user device mapping data. The user device mapping data may comprise data received from one or more mobile devices (e.g., mobile devices 107A and 107B). The user device mapping data may comprise mobile device location data (e.g., one or more latitudes and longitudes associated with a mobile device of the one or more mobile devices at a given time). The user device mapping data may comprise at least one user device identifier associated with at least one user device (e.g., user device ID 102). The user device identifier field may maintains identification information on tracked mobile devices and/or users, and may also include contact information (e.g., IP address, email, phone number, etc.) to enable communication with the mobile device/user. Such identification information may include the name of the user (e.g., Joe Smith) and/or his/her device identifier (e.g., 1111111). Identification information may take any form suitable to enable identification of a mobile user or the mobile device.

The user device mapping data may comprise information such as one or more dates and one or more times. The one or more data and one or more times may indicate a date and/or a time at which a mobile device of the one or more mobile devise detected a signal from a given user device. The user device mapping data may include signal data indicating a signal characteristic (e.g., a received signal strength indicator or “RSSI”). The user device mapping data may include activity data indicating the type of signal the mobile device detected (e.g., a Wi-Fi beacon, a Bluethooth Beacon, a 5G call, etc. . . . ). Further, the user device mapping data may indicate a direction from which the detected signal originated.

For example, with respect to mobile device 107A, the detected signals from user device 102 are originally received by the mobile device 107A with an initial RSSI of 1.5 dB originating Northeast of the mobile device 107A's location. As time progresses, and mobile device 107A moves (as evidenced by changes in latitude and/or changes in longitude) the signal increases in strength suggesting the mobile device 107A is getting closer to the user device 102. Simultaneously, the direction from which the signal originated is changing from Northeast to East, suggesting the mobile device 107A is approaching the user device 102 from the Southwest and drawing level with the user device 102. Then, the signal decreases in strength whilst the direction of origin changes East to Southeast suggesting the mobile device 107A is moving away from the user device 102 in a Northwest direction. Similarly, with respect to mobile device 107B, the detected signals from user device 102 are originally received by the mobile device 107B with an initial RSSI of 1.5 dB originating Northwest of the mobile device 107B's location. As time progresses, and mobile device 107B moves (as evidenced by changes in Lat/Long), the signal increases in strength suggesting the mobile device 107B is getting closer to the user device 102. Simultaneously, the direction from which the signal originated is changing from Northwest to West, suggesting the mobile device 107A is approaching the user device 102 from the Southwest and drawing level with the user device 102. Then, the signal decreases in strength whilst the direction of origin changes West to Southwest suggesting the mobile device 107B is moving away from the user device 102 in a Northeast direction.

The computing device may maintain movement information for each mobile device and/or user device, and corresponding date/time identifies the time at which the information was determined or received. Movement information may include a position or location of the mobile device. The position or location may take the form of a specific geographic area (e.g., area 1, area 5, etc.), longitude/latitude, street address, or any form in which a location or vicinity of the device may be determined. Movement information may take other forms including movement characteristics, such as a route, velocity, acceleration, etc. By tracking the position and time, it is possible to determine the speed or velocity at which a mobile device and/or user device is traveling as well as the route. Such information may be employed to determine a traffic condition or other group properties.

One example use involve the determination of traffic conditions at a particular location. For example, the computing device may identify a group of mobile devices and/or user devices from a plurality of user devices associated with users driving on a particular road, determine a group property such an average speed or traffic pattern of the mobile devices in the group based on the movement of the devices, and derive a traffic condition based on the determined group property. Traffic conditions may include congested traffic flow, normal traffic flow, and so forth. This information may be provided to one or more mobile devices in the group, one or more mobile devices in a second group traveling towards the pertinent traffic area and/or a traffic-related agency, such as a traffic reporting agency or the like. This information may also be employed to customize services to the one or more mobile devices in the group, such as determining and providing alternative routes in the event of traffic congestion, providing traffic news services, etc.

Similarly, another example may involve the determination of mobile communication conditions at a particular location, such as within a cell site. For example, the computing device may identify a group of mobile devices and/or user devices at a particular location (e.g., cell site), determine a group property such an average number of calls or communications by the group (e.g., or group usage pattern), and derive communications conditions at the location based on group property. Such information may be employed by wireless communication provider(s) to increase communication efficiency, e.g., reroute calls or other wireless connections and so forth.

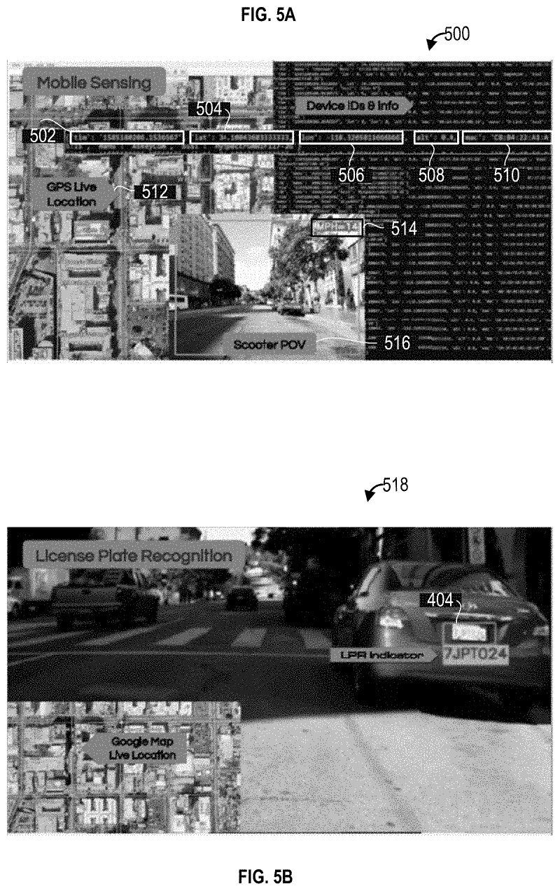

FIG. 5 illustrates a visualization of mobile sensing data 500. The signal data referenced herein may comprise the mobile sensing data 500. For example, the mobile sensing data 500 may comprise a time 502, a location comprising, for example, a latitude 504, a longitude 506, an altitude 508, a GPS live location 512 a device identifier 510 (for example, a MAC address), a speed 514 (for example, in miles per hour), a direction of travel, combinations thereof, and the like. The speed 514 may indicate a speed associated with a mobile device (e.g., the mobile device 107A). The aforementioned are merely exemplary and explanatory and are not meant to be limiting. It is to be understood that the mobile sensing data may comprise any data associated wither any of the signals or devices described herein. The mobile sensing data may comprise the visual described herein. For example, the visual data may comprise a scooter POV (point of view) 416.

FIG. 5B illustrates an embodiment wherein the device mapping data may be associated with object recognition data 518. The object recognition data may comprise license plate recognition data. For example, the object recognition data may comprise an image of a license plate. For example, the object recognition data may determine, based on the image of the license plate, a license plate number. For example, the license plate number shown in FIG. 5B is 7JPTO24. The object recognition data may comprise a license plate recognition indicator (LPR indicator) 520. The LPR indicator may indicate a license plate number has been correctly identified as a license plate number and may further indicate a combination of letters and numbers which the license plate number may comprise.

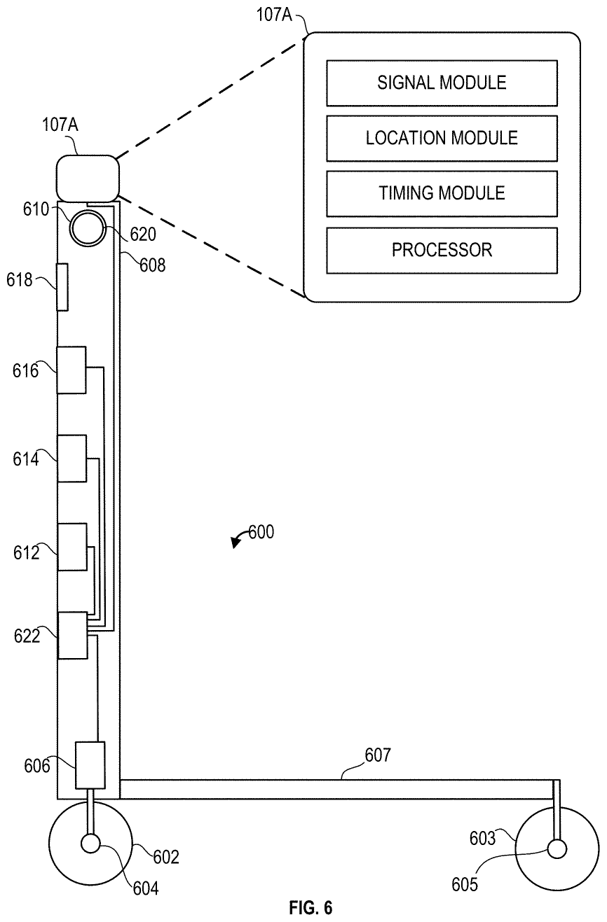

FIG. 6, shows an embodiment wherein the mobile device 107A (e.g., the mobile data collection apparatus) is mounted on a micromobility scooter 600. The mobile device 107A may comprise one or more sensors. The one or more sensors may include one or more of a signal sensor, a radar sensor, an image sensor, an accelerometer, a proximity sensor, an imaging sensor, a GPS sensor, combinations thereof, and the like. For example, the one or more sensors may comprise a signal sensor 612, a proximity sensor 614, and an imaging sensor 616. For example, he signal sensor 612 may be configured for detecting signals (e.g., one or more signals associated with one or more wireless communications) in the environment of the electronic device 102 and generating communication data. For example, the signal sensor 612 may comprise an antennae. The signal sensor 612 may be an autonomous network yard analyzer (ANYA) device manufactured by AES Controls, or a similar device. The signal sensor 612 may be configured to detect signals from third party electronic devices such as cell phones, laptops, smartphones, and other consumer electronics. For example, the signal sensor 612 may detect a signal (e.g., a data packet or the like) transmitted via a network, for example, a wireless network. The signal may comprise a message, a probe request, a broadcast, combinations thereof, and the like. The signal sensor may detect the signal and signal information. The signal information may comprise, for example, a signal strength identifier (e.g., an RSSI), an identifier associated a device sending the signal (e.g., a sending MAC address), an identifier associated with an intended recipient device (e.g., a receiving MAC address), an identifier associated with the network via which the signal is transmitted (e.g., an SSID), a protocol identifier, a key, combinations thereof, and the like. For example, the signal sensor 612 may detect a message being sent from a first smartphone to a second smartphone via a wireless network (e.g., an email being sent from the first smartphone to the second smartphone via a 4G wireless network). The signal sensor 612 may determine a first identifier (e.g., a first MAC address) associated with the first smartphone and a second identifier (e.g., a second MAC address) associated with the second smartphone. The signal senor 612 may send the signal information to the computing device 101 for processing. The computing device 101 may determine additional signal information such as, for example, location information associated with the location at which the mobile device 107A was located when the data packet was detected (for example via a GPS module). The location information may comprise a latitude, a longitude, an elevation (e.g., altitude), combinations thereof, and the like. The computing device 101 may store the location information in memory.

The mobile device 107A may comprise an imaging sensor 616. The imaging sensor 616 may be configured to capture visual data. The visual data may comprise still image data (e.g., a picture) and/or video data (e.g., video frames and/or sequential image frames). For example, the imaging sensor 616 may comprise a camera and/or a video camera. The imaging sensor 616 may be configured for determining objects through object recognition or other known techniques (e.g., edge detection and the like). The imaging sensor 616 may be configured to send visual data. For example, the imaging sensor 616 may capture the visual data and send the visual data to the computing device 101 (e.g., the electronic device 201) for processing. The computing device 101 may receive the visual data. The computing device 101 may process the visual data. For example, the computing device 101 may perform object recognition analysis on the visual data. For example, the computing device 101 may determine the visual data comprises an image of a vehicle. For example, the computing device 101 may determine the visual data comprises an image of a license plate. The computing device 101 may determine license plate recognition (LPR) data. The computing device 102 may comprise a processor 622. The processor 622 may comprise the wireless network interface. The wireless network interface may be a Bluetooth connection, an antenna, or other suitable interface. In one embodiment, the wireless network interface is a Bluetooth Low Energy (BLE) module. In one non-limiting example, the wireless network interface and the processor 622 are integrated in one unitary component, such as a RFduino microcontroller with built-in BLE module, a Nordic Semiconductor microcontroller, a Cypress microcontroller with BLE module, or a BLE enabled Raspberry Pi. The processor 622 may be configured to receive sensor data (environmental information) from each of the various sensors of the mobile device 107A. The processor 622 may provide some or all of the environmental information to the computing device 101.

The computing device 101 may be configured to determine, based on the visual data, an image of a person. The computing device 101 may be configured to implement a facial recognition technique. For example, the electronic device may receive the visual data from the imaging sensor, determine a face in the visual data, and compare the face to a database of faces. The database of faces may comprise a plurality of faces, wherein each face of the plurality of faces are associated with at least one personal identifier. The at least one personal identifier may comprise a name, an address, a license plate number, a vehicle identification number (VIN), tax information (e.g., personal property tax), combinations thereof, and the like.

The signal sensor 612, the proximity sensor 614, the imaging sensor 616, the processor 622 and/or other components may be disposed on a micromobility scooter 600. The scooter 600 may comprise a front wheel assembly having a front wheel 602 and front axle 604 as well a rear wheel assembly having a rear wheel 606 and a rear axle 605. The front wheel 602 and the rear wheel 606 may each comprise a rubber wheel. The front axle 604 may extend from at least one side of the front wheel 602. The rear axle 605 may extend from at least one side of the rear wheel 606. A motor 606 may be configured to rotate the front wheel 602 and/or the rear wheel 606 via a drive shaft (or other motion transfer system, e.g., chain). The front wheel assembly and rear wheel assembly may be joined by a platform 607. The platform 607 may comprise at least one metal piece configured to support a rider thereon (e.g., a stepboard). The micromobility scooter 600 may comprise a post 608 connected to the front wheel assembly (e.g., the axle 604) at a proximal end, the post 608 extending away from the front wheel assembly toward a handle 610 positioned at a distal end of the post 608, the handle 610 being configured to be gripped by an operator. A tactile feedback device 620 may be embedded in the handle 610. In one embodiment, the handle 610 may have an integrated accelerator/decelerator configured to drive the motor 606. For example, rotating the handle 610 in a forward direction (relative to a direction of travel) may cause the motor to propel either or both of the front wheel 602 and the rear wheel 606. Likewise, releasing the handle 610, or allowing the handle 610 to rotate towards a neutral position (relative to the direction of travel) may cause the motor 606 to discontinue propelling either or both of the front wheel 602 and the rear wheel 606.

The mobile device 107A may comprise a proximity sensor 614 affixed to the post 608. The proximity sensor 614 may be configured for detecting the environment in the path of the micromobility scooter 600 and generating ultrasonic data. The scooter 600 may comprise a power source (not shown) configured to power the motor 306 and other electronics of the mobile device 107A. For example, the power source may be a battery, a solar cell, a hydrogen cell, a fuel powered engine, combinations thereof, and the like.

In an embodiment, the scooter 600 may comprise a computing device (e.g., the mobile device 107A) affixed to the post 608. The computing device may be a smartphone, a smart watch, a smart glass, a tablet, a laptop, combinations thereof, and the like. The mobile device 107A may be configured to determine the path of the micromobility scooter 600, engage the motor 606 to cause the micromobility scooter 600 to proceed along the path, receive the signal and the visual data and process the signal and visual data. The mobile device 107A may be configured to transmit the signal data and the visual data to a remote computing device 101.

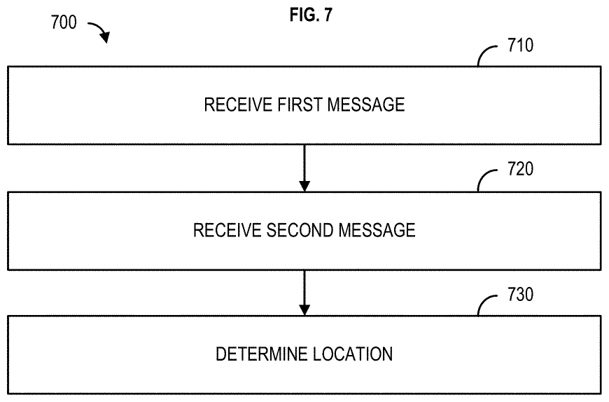

FIG. 7 shows an example method. FIG. 7 shows an example method 700. The method 700 may be executed by any of the devices described herein or any combination thereof (e.g., any of the mobile devices 107A or 107B, and/or the computing device 101). At 710, a first message may be received. The first message may be received by, for example, the computing device 101. The first message may be sent by a first mobile device of a plurality of mobile devices (e.g., the mobile device 107A). The first message may comprise a mobile device identifier associated with the first mobile device. The first message may comprise a location associated with the first mobile device such as, for example, GPS coordinates. The first message may comprise a user device identifier. The message may indicate one or more signals associated with the user device have been detected. For example, the one or more signals may comprise a beacon, a probe-request, combinations thereof, and the like. The message may indicate one or more signal characteristics. For example, a first signal characteristic of the one or more signal characteristics may be a received signal strength indicator. For example, a second signal characteristic of the one or more signal characteristics may be a direction (e.g., a direction from which a signal of the one or more signals originated. The signal may comprise one or more signals from third party electronic devices such as cell phones, laptops, smartphones, and other consumer electronics. For example a signal sensor may detect a signal (e.g., a data packet or the like) transmitted via a network, for example, a wireless network. The signal may comprise a message, a probe request, a broadcast, combinations thereof, and the like. The signal sensor may detect the signal and signal information.

At 720, a second message may be received. The second message may be received by, for example, the computing device 101. The second message may be sent by a second mobile device of the plurality of mobile devices (e.g., the mobile device 107B). The second message may comprise a mobile device identifier associated with the second mobile device. The first message may comprise a location associated with the second mobile device such as, for example, GPS coordinates. The second message may comprise the user device identifier. The message may indicate one or more signals associated with the user device have been detected. For example, the one or more signals may comprise a beacon, a probe-request, combinations thereof, and the like. The message may indicate one or more signal characteristics. For example, a first signal characteristic of the one or more signal characteristics may be a received signal strength indicator. For example, a second signal characteristic of the one or more signal characteristics may be a direction (e.g., a direction from which a signal of the one or more signals originated. The signal may comprise one or more signals from third party electronic devices such as cell phones, laptops, smartphones, and other consumer electronics. For example a signal sensor may detect a signal (e.g., a data packet or the like) transmitted via a network, for example, a wireless network. The signal may comprise a message, a probe request, a broadcast, combinations thereof, and the like. The signal sensor may detect the signal and signal information.

At step 730, a location of the user device may be determined. The location of the user device may be determined via a network triangulation. The network triangulation may comprise determining one or more associations between the one or more signal characteristics and one or more distances and/or locations. For example, based on a first device type of a first device, the computing device may determine a first RSSI associated with a first device type, is indicative of a first distance. Similarly, based on a second device type of a second device, the computing device may determine a second RSSI is indicative of a second distance.

The method may further comprise determining one or more locations associated with one or more user devices. For example, the above method may be repeated for the one or more user devices. The method may further comprise determining user device mapping data wherein the user device mapping data is configured to indicate one or more locations of the one or more user devices. The method may further comprise determining, based on the one or more locations of the one or more user devices, user device congestion data, user device traffic data, user device location density data, and other related information. The method may comprise determining, based on at least one of the user device congestion data, the user device traffic data, or the user device location density data, one or more optimal access point locations. The one or more optimal access point locations may indicate a geographic location which is underserved by a hardware associated with a network provider.

The method may further comprise receiving image data. The image data may be received based on an image captured by the imaging sensor. For example, the imaging sensor may comprise a camera. The camera may capture still images or video footage and relay them as image data to, for example, the computing device 101. The image data may comprise images of people, cars, license plates, buildings, street signs, or any other objects whether animate or inanimate.

The method may further comprise determining object data. For example, object data may comprise license plate recognition data. For example, the object data may comprise an image of a license plate. For example, the object recognition data may determine, based on the image of the license plate, a license plate number. Likewise, the object data may comprise facial recognition data. For example, the facial recognition data may be associated with a person or a group of persons.

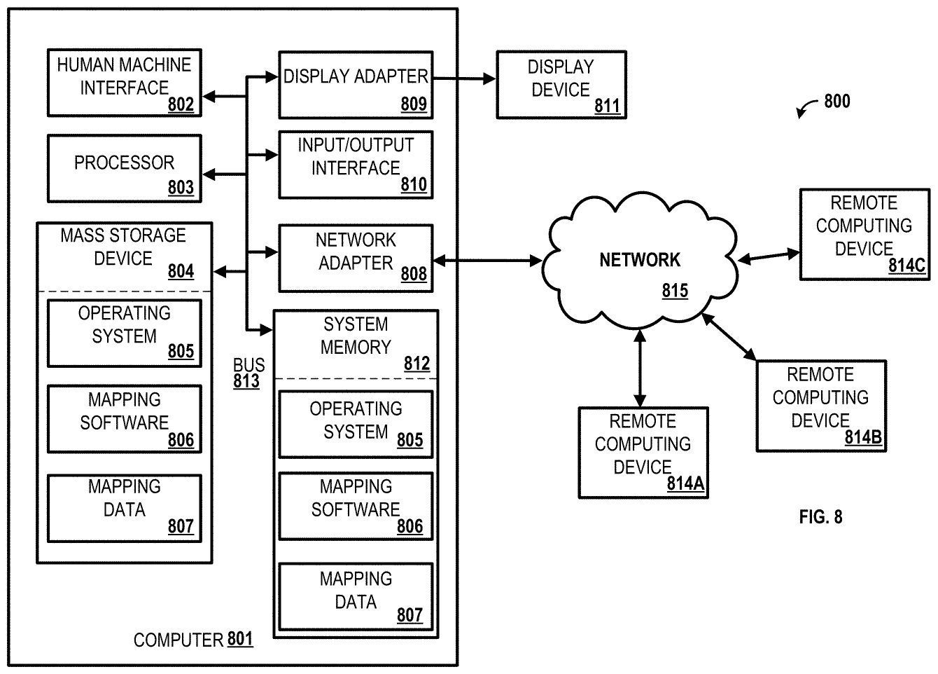

The above described disclosure may be implemented on a computer 801 as illustrated in FIG. 8 and described below. By way of example, the computing device 101 of FIG. 1 can be a computer as illustrated in FIG. 8. Similarly, user device 102 may be a computer as illustrated in FIG. 8. Likewise, the computing device 101, the mobile device 107A, the mobile device 107B, or the user device 102 may be a remote computing device (e.g., remote computing devices 814A, 814B, or 814C) of FIG. 8. FIG. 8 is a block diagram illustrating an example operating environment for performing the disclosed methods. This example operating environment is only an example of an operating environment and is not intended to suggest any limitation as to the scope of use or functionality of operating environment architecture. Neither should the operating environment be interpreted as having any dependency or requirement relating to any one or combination of components illustrated in the example operating environment.

The present disclosure can be operational with numerous other general purpose or special purpose computing system environments or configurations. Examples of well-known computing systems, environments, and/or configurations that can be suitable for use with the systems and methods comprise, but are not limited to, personal computers, server computers, laptop devices, and multiprocessor systems. Examples comprise set top boxes, programmable consumer electronics, network PCs, minicomputers, mainframe computers, distributed computing environments that comprise any of the above systems or devices, and the like.

The processing of the disclosed can be performed by software components. The disclosed systems and methods can be described in the general context of computer-executable instructions, such as program modules, being executed by one or more computers or other devices. Generally, program modules comprise computer code, routines, programs, objects, components, data structures, etc. that perform particular tasks or implement particular abstract data types. The disclosed methods can also be practiced in grid-based and distributed computing environments where tasks are performed by remote processing devices that are linked through a communications network. In a distributed computing environment, program modules can be located in both local and remote computer storage media including memory storage devices.

Further, one skilled in the art will appreciate that the systems and methods disclosed herein can be implemented via a general-purpose computing device in the form of a computer 801. The components of the computer 801 can comprise, but are not limited to, one or more processors 803, a system memory 812, and a system bus 813 that couples various system components including the one or more processors 803 to the system memory 812. The system can utilize parallel computing.

The system bus 813 represents one or more of several possible types of bus structures, including a memory bus or memory controller, a peripheral bus, an accelerated graphics port, or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 813, and all buses specified in this description can also be implemented over a wired or wireless network connection and each of the subsystems, including the one or more processors 803, a mass storage device 804, an operating system 805, mapping software 806, mapping data 807, a network adapter 808, the system memory 812, an Input/Output Interface 810, a display adapter 809, a display device 811, and a human machine interface 802, can be contained within one or more remote computing devices 814A, 814B, 814C at physically separate locations, connected through buses of this form, in effect implementing a fully distributed system.

The computer 801 typically comprises a variety of computer readable media. Example readable media can be any available media that is accessible by the computer 801 and comprises, for example and not meant to be limiting, both volatile and non-volatile media, removable and non-removable media. The system memory 812 comprises computer readable media in the form of volatile memory, such as random access memory (RAM), and/or non-volatile memory, such as read only memory (ROM). The system memory 812 typically contains data such as the mapping data 807 and/or program modules such as the operating system 805 and the mapping software 806 that are immediately accessible to and/or are presently operated on by the one or more processors 803.

The computer 801 can also comprise other removable/non-removable, volatile/non-volatile computer storage media. By way of example, FIG. 8 illustrates the mass storage device 804 which can facilitate non-volatile storage of computer code, computer readable instructions, data structures, program modules, and other data for the computer 801. For example and not meant to be limiting, the mass storage device 804 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 804, including by way of example, the operating system 805 and the mapping software 806. Each of the operating system 808 and the mapping software 806 (or some combination thereof) can comprise elements of the programming and the mapping software 806. The mapping data 807 can also be stored on the mass storage device 804. The mapping data 807 can be stored in any of one or more databases known in the art. Examples of such databases comprise, DB2®, Microsoft® Access, Microsoft® SQL Server, Oracle®, mySQL, PostgreSQL, Mongo, Cassandra, and the like. The databases can be centralized or distributed across multiple systems.

The user or device can enter commands and information into the computer 801 via an input device (not shown). Examples of such input devices comprise, but are not limited to, a keyboard, pointing device (e.g., a “mouse”), a microphone, a joystick, a scanner, tactile input devices such as gloves, and other body coverings, and the like These and other input devices can be connected to the one or more processors 803 via the human machine interface 802 that is coupled to the system bus 813, but can be connected by other interface and bus structures, such as a parallel port, game port, an IEEE 1394 Port (also known as a Firewire port), a serial port, or a universal serial bus (USB).

The display device 811 can also be connected to the system bus 813 via an interface, such as the display adapter 809. It is contemplated that the computer 801 can have more than one display adapter 809 and the computer 801 can have more than one display device 811. For example, the display device 811 can be a monitor, an LCD (Liquid Crystal Display), an augmented reality (AR) display, a virtual reality (VR) display, a projector, combinations thereof, and the like. In addition to the display device 811, other output peripheral devices can comprise components such as speakers (not shown) and a printer (not shown) which can be connected to the computer 801 via the Input/Output Interface 810. Any step and/or result of the methods can be output in any form to an output device. Such output can be any form of visual representation, including, but not limited to, textual, graphical, animation, audio, tactile, and the like. The display device 811 and computer 801 can be part of one device, or separate devices.

The computer 801 can operate in a networked environment using logical connections to one or more remote computing devices 814A, 814B, 814C. By way of example, a remote computing device can be a gaming system, personal computer, portable computer, smartphone, a server, a router, a network computer, a peer device or other common network node, and so on. Logical connections between the computer 801 and a remote computing device 814A, 814B, 814C can be made via a network 818, such as a local area network (LAN) and/or a general wide area network (WAN). Such network connections can be through the network adapter 808. The network adapter 808 can be implemented in both wired and wireless environments. Such networking environments are conventional and commonplace in dwellings, offices, enterprise-wide computer networks, intranets, and the Internet.

For purposes of illustration, application programs and other executable program components such as the operating system 805 are illustrated herein as discrete blocks, although it is recognized that such programs and components reside at various times in different storage components of the computing device 801, and are executed by the one or more processors 803 of the computer. An implementation of the selective mapping software 806 can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” comprise volatile and non-volatile, removable and non-removable media implemented in any methods or technology for storage of information such as computer readable instructions, data structures, program modules, or other data. Example computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

The disclosure can employ Artificial Intelligence techniques such as machine learning and iterative learning. Examples of such techniques include, but are not limited to, expert systems, case based reasoning, Bayesian networks, behavior based AI, neural networks, fuzzy systems, evolutionary computation (e.g. genetic algorithms), swarm intelligence (e.g. ant algorithms), and hybrid intelligent systems (e.g. Expert inference rules generated through a neural network or production rules from statistical learning).

While the disclosure has been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as an example only, with a true scope and spirit being indicated by the following claims.

What is claimed is:

1. A method comprising:
receiving, from a first device, a first message comprising a user device identifier, wherein the user device identifier is associated with a first signal characteristic;
receiving, from a second device, a second message comprising the user device identifier, wherein the user device identifier is associated with a second signal characteristic; and
determining, based on the user device identifier, the first signal characteristic and the second signal characteristic, a location of a user device relative to the first device and relative to the second device, wherein the user device is associated with the user device identifier.

2. The method of claim 1, wherein the first device and the second device comprise at least one mobile data collection device.

3. The method of claim 1, wherein the user device comprises at least one of: a smart phone, a laptop, a computer, or a tablet.

4. The method of claim 1, wherein the first message further comprises first location data and first timing data and wherein the second message further comprises second location data and second timing data.

5. The method of claim 4, further comprising:
determining, based on the location of the user device relative to the first device and the second device, device location history data; and
determining, based on the device location history data, an access point location.

6. The method of claim 1, wherein determining the location of the user device relative to the first device and relative to the second device comprises determining, via network triangulation based on the first signal characteristic and the second signal characteristic, the location of the user device.

7. The method of claim 1, wherein at least one of the first signal characteristic and the second signal characteristic comprises at least one of: a received signal strength indicator (RSSI), a packet loss indicator, a transmission strength indicator, or a modulation rate indicator.

8. A system, comprising:
a computing device configured to:
receive, from a first device, a first message comprising a user device identifier, wherein the user device identifier is associated with a first signal characteristic;
receive, from a second device, a second message comprising the user device identifier, wherein the user device identifier is associated with a second signal characteristic;
determine, based on the user device identifier, the first signal characteristic and the second signal characteristic, a location of a user device relative to the first device and relative to the second device, wherein the user device is associated with the user device identifier; and
the first device, configured to send, to the computing device, the first message.

9. The system of claim 8, wherein the first device and the second device comprise at least one mobile data collection device.

10. The system of claim 8, wherein the user device comprises at least one of: a smart phone, a laptop, a computer, or a tablet.

11. The system of claim 8, wherein the first message further comprises first location data and first timing data and wherein the second message further comprises second location data and second timing data.

12. The system of claim 8, wherein the computing device is further configured to determine, based on the location of the user device relative to the first device and the second device, device location history data.

13. The system of claim 8, wherein the computing device is configured to determine the location of the user device relative to the first device and relative to the second device by determining, via network triangulation based on the first signal characteristic and the second signal characteristic, the location of the user device.

14. The system of claim 8, wherein at least one of the first signal characteristic and the second signal characteristic comprises at least one of: a received signal strength indicator (RSSI), a packet loss indicator, a transmission strength indicator, or a modulation rate indicator.

15. An apparatus comprising:
one or more processors; and
memory storing processor executable instructions that, when executed by the one or more processors, cause the apparatus to:
receive, from a first device, a first message comprising a user device identifier, wherein the user device identifier is associated with a first signal characteristic;
receive, from a second device, a second message comprising the user device identifier, wherein the user device identifier is associated with a second signal characteristic; and
determine, based on the user device identifier, the first signal characteristic and the second signal characteristic, a location of a user device relative to the first device and relative to the second device, wherein the user device is associated with the user device identifier.

16. The apparatus of claim 15, wherein the first device and the second device comprise at least one mobile data collection device.

17. The apparatus of claim 15, wherein the user device comprises at least one of: a smart phone, a laptop, a computer, or a tablet.

18. The apparatus of claim 15, wherein the first message further comprises first location data and first timing data and wherein the second message further comprises second location data and second timing data.

19. The apparatus of claim 15, wherein the processor executable instructions, when executed by the one or more processors, further cause the apparatus to:
determine, based on the location of the user device relative to the first device and the second device, device location history data; and
determine, based on the device location history data, an access point location.

20. The apparatus of claim 15, wherein at least one of the first signal characteristic and the second signal characteristic comprises at least one of: a received signal strength indicator (RSSI), a packet loss indicator, a transmission strength indicator, or a modulation rate indicator.
